(19) United States
(12) Patent Application Publication
(10) Pub. No.: US 2015/0296763 A1
(43) Pub. Date: Oct. 22, 2015

(54) Fishing Belt

(71) Applicant: David Alan Sanders, Godfrey, IL (US)

(72) Inventor: David Alan Sanders, Godfrey, IL (US)

(21) Appl. No.: 14/257,533

(22) Filed: Apr. 21, 2014

(51) Int. Cl. A01K 97/10; A01K 97/00

(52) U.S. Cl. CPC A01K 97/10; A01K 97/00

(57) ABSTRACT

A sport fishing belt support system that can be worn in several different positions. The present invention is composed of a pressure distributing back plate, three fishing rod receptacles mounted to the front and both sides of the back plate combined with a centered stop plate for the side receptacles: a waist belt where said waist belt is being strapped around the user's waist; a Velcro strap and or a strap with attached buckle to secure the waist belt; a padding attached to the back plate so that the fishing rod when mounted will help maintain a comfortable, customary angle normally used for fishing that the fishing pole will perform optimally.

### BACKGROUND

Wherever you find a body of water you will find fisherman. And where you find fisherman you will find an array of fishing equipment. When fishing for larger fish one of the challenges with catching a fish is the mechanics one must go through in the process. Once the fish is hooked, the process begins and leverage becomes an issue. If a fishing belt is not available the fisherman immediately feels the pressure and starts looking for leverage. Stabilizing the rod usually involves holding the pole above the reel with one hand and planting the butt of the pole under the armpit or gouging the butt of the rod somewhere into the abdominal or upper thigh area. Any fisherman who has fished for larger fish without a fishing belt can attest to the sore body areas, bruising, and abrasions left as a result. As the fisherman begins reeling his catch in, he is pumping the rod back and forth in a raising and lowering motion of the tip of the rod. The area that stabilizes the butt of the rod is now under intense pressure. The fisherman has to exert extra strength throughout his body as the fish fights back.

When fishing for larger fish, larger fishing tackle is needed, such as fishing belts and larger rod and reels. As with life many things can prevent someone from wearing the traditional type of fishing belt, from age to physical condition.

Some fishermen have used a pouch and loop usually made of leather or fabric material which attaches to their belt over their hip or attaches to their leg U.S. Pat. No. 6,591,542 B1. The butt of the rod is inserted into the pouch or loop when in the angling position. This type of apparatus fails to evenly distribute the pressure and places the direct stress in a small area where attached.

The traditional fishing belts are generally worn one way resting up against the lower torso or abdominal area U.S. Pat. No. 4,817,323. One of the problems are not all fisherman are alike and yet they like to fish. Many people are not capable of having pressure applied to the abdominal area because of various reasons. Other rod holders have been invented to be attached to the fisherman's belt or trousers U.S. Pat. No. 5,044,109. Each of these fail to give a stable anchoring, leverage, even pressure distribution or options of how to wear.

### SUMMARY OF THE INVENTION

A multi-positional sport fishing belt that offers its wearer options based on comfort, support and versatility.

### BRIEF DESCRIPTION OF DRAWINGS

FIG. 1 Is a perspective of the front view of the device.

FIG. 2 Is a perspective of a tilted front view of the device with numbered and named features.

FIG. 3 is a perspective front view of the device with numbered and named features.

FIG. 4, Is a perspective front view of the bottom with numbered and named features.

FIG. 5, Is a perspective view of how the fishing belt can be worn on the right hip area with numbered and named features.

FIG. 6, Is a perspective view of how the fishing belt is worn in the traditional manner.

FIG. 7, Is a perspective side view of how the fishing belt is worn in the traditional manner.

### DESCRIPTION

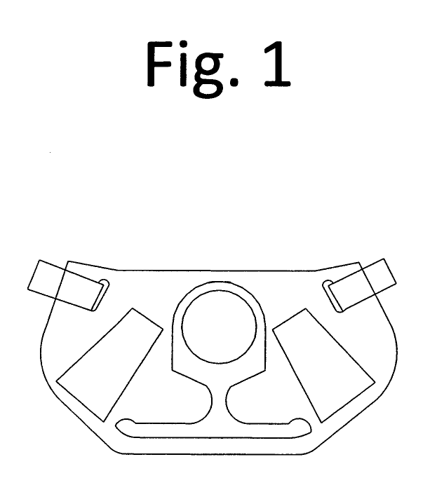

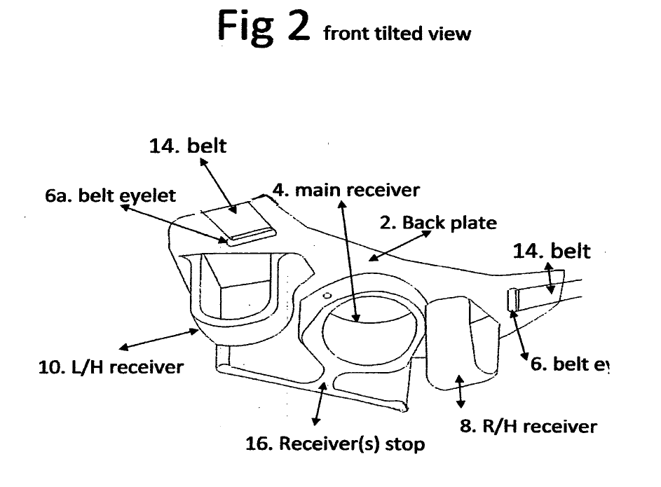

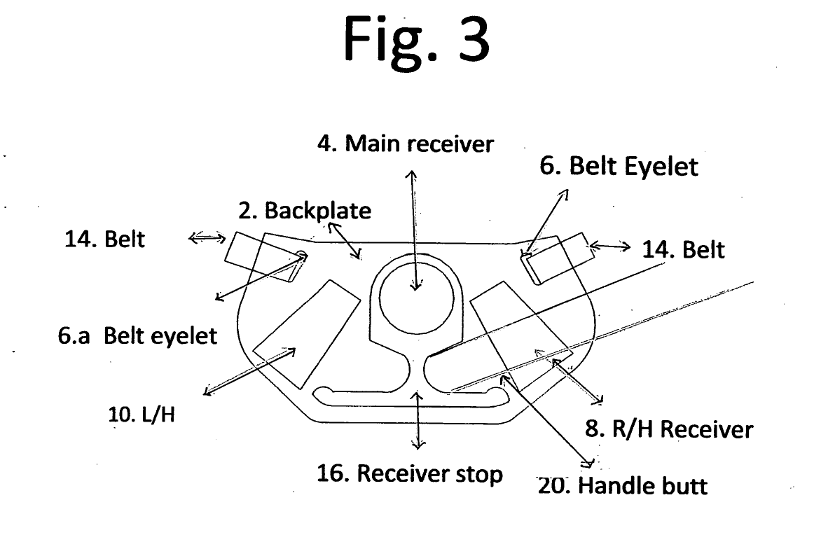

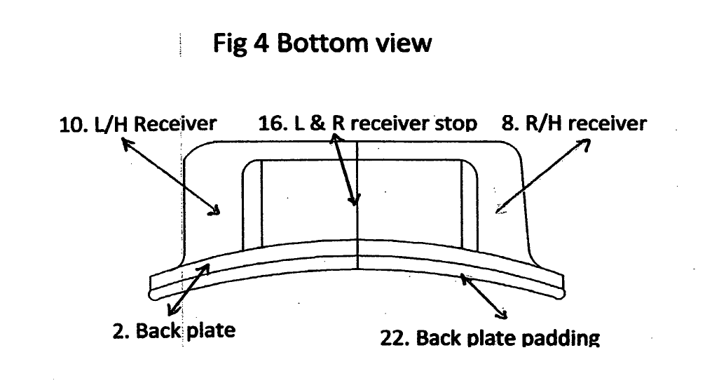

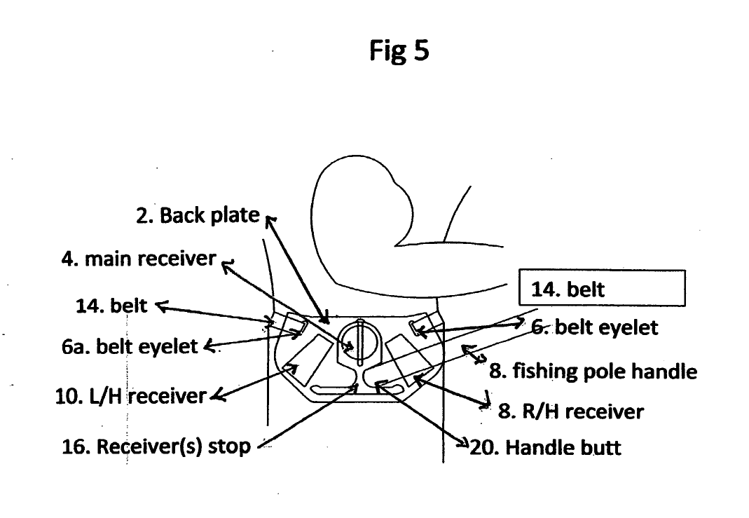

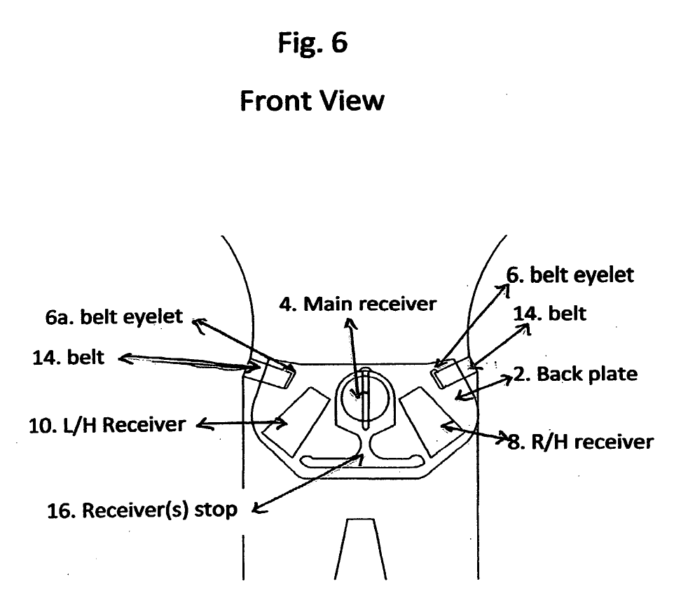

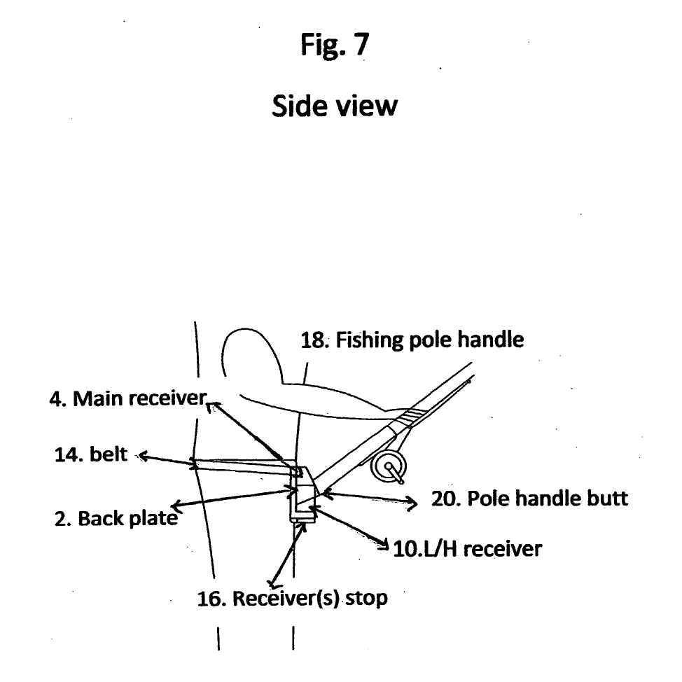

Starting with the drawings (FIG. 1) shows the front view of the fishing belt. (FIG. 2) shows the front view looking down at an angle. The sport fishing belt is comprised of a back plate that helps distribute pressure across the abdomen when worn in the traditional manner (FIG. 6.) With references to the device is a rigid fixture which can be made of suitable material such as plastic, metal, fiberglass, or the like. In reference to all of the (FIGS. 1-7) when fishing for larger fish it is very often that the fisherman may have to hold the rod and reel for extended periods of time. The combination of equipment, currents, weather conditions and the fight of the fish when hooked increases the resistance and pressure on the fisherman and equipment. The back plate is curved to hug the contour of the body for comfort, support and distribution of pressure. (FIG. 4, 2) The reverse side of the back plate is fitted with a resilient cushioning material such as a foam rubber or like material to help hug the body and enhance the comfort (FIG. 4, 22). The front surface of the back plate has a main receiver (FIG. 3, 2) which is designed to receive the handle of a standard fishing rod. By using the equipment in this manner the pressure from the rod is evenly distributed across the abdominal area. If the fisherman chooses not to wear the sport fishing belt in the traditional manner (FIG. 6) for whatever reason, be it physical or preference. The fishing belt be moved to the body side of preference wearing it on their hip (FIG. 5) or above the belt line. The natural curve of the back plate (FIG. 4, 2) and design of stop plate (FIG. 3, 16) helps distribute pressure along the back plate. On each side of the main receiver attached to the back plate are 2 additional collar receivers (FIGS. 3, 8 & 10) designed for the standard fishing rod handle. The collar receivers (FIGS. 3, 8 & 10) guide the rod handle in a diagonal angle. As the butt of the fishing pole comes into contact with the receiver stop (FIG. 3, 16) the fishing pole (FIG. 3, 18) can become gripped between the lower front edge of the receiver collar (FIG. 3, 8) and the designed edges of the receiver stop (FIG. 3, 16). When used in this position the rod assumes a comfortable customary angle normally used for fishing. The sport fishing belt is held in place by the contoured back (FIG. 4, 2) of the back plate with padded surface (FIG. 4, 22) and an adjustable belt (FIG. 3, 14) The belt being made from such materials as nylon webbing, leather or other such suitable materials and means of attachment such as Velcro, adjustable buckles, and other such materials including sewn ends.

What is claimed is:

1. A device for holding a fishing rod to the body while wearing in one of multiple positions.

2. A device where the main receiver holds the butt of the fishing rod while resting against the Abdominal area.

3. A device for holding the fishing rod to the body while being worn on either hip.

4. The device of claim 2 wherein the acute angle of the receivers are about 45 degrees.
